(19) United States
(12) Patent Application Publication
(10) Pub. No.: US 2009/0115749 A1
(43) Pub. Date: May 7, 2009

(54) INPUT DEVICE

(76) Inventors: Han Cheol Kim, Hwaseong-si (KR); Jin Suk Han, Anyang-si (KR); Young Gil An, Seoul (KR)

Correspondence Address: SALIWANCHIK LLOYD & SALIWANCHIK;A PROFESSIONAL ASSOCIATION, PO Box 142950, GAINESVILLE, FL, 32614, US

(21) Appl. No.: 12/266,138

(22) Filed: Nov. 6, 2008

(30) Foreign Application Priority Data
Nov. 7, 2007 (KR) 10-2007-0113156
Nov. 12, 2007 (KR) 10-2007-0114821

(51) Int. Cl. G09G 5/00

(52) U.S. Cl. 345/184

(57) ABSTRACT

Disclosed is an input device. The input device includes a substrate including a sensor, a housing having an opening on the substrate, a sliding member slidably installed between the housing and the substrate, a sensing plate coupled with the sliding member to face the sensor, and a magnetic substance circumferentially provided in one of the sliding member and the housing and a magnet circumferentially provided in remaining one of the sliding member and the housing.

### CROSS-REFERENCE TO RELATED APPLICATIONS

The present application claims the benefit under 35 U.S.C. §119(e) of Korean Patent Applications No. 10-2007-0113156, filed Nov. 7, 2007 and 10-2007-0114821, filed Nov. 12, 2007, which are hereby incorporated by reference in their entirety.

### BACKGROUND

Electronic appliances such as a mobile phone, a personal digital assistant (PDA), and an MP3 player include an information input device inputting manipulation commands of a user.

Such an information input device is classified into a button-type information input device to input on/off signals and a wheel-type information input device to input a specific manipulation command according to the rotation of a wheel thereof.

### BRIEF SUMMARY

An embodiment provides an input device having a new structure.

An embodiment provides a sliding-type input device.

An embodiment provides an input device having restoring force.

According to an embodiment, an input device includes a substrate including a sensor, a housing having an opening on the substrate, a sliding member slidably installed between the housing and the substrate, a sensing plate coupled with the sliding member to face the sensor, a magnetic substance circumferentially provided in one of the sliding member and the housing, and a magnet circumferentially provided in remaining one of the sliding member and the housing.

According to an embodiment, an input device includes a substrate including a sensor, a housing having an opening on the substrate, a sliding member slidably installed between the housing and the substrate, a sensing plate coupled with the sliding member to face the sensor, a first magnet installed in the sliding member and having a ring shape, and a second magnet installed in the housing and having a ring shape, wherein the first magnet is at least partially overlapped with the second magnet, and overlapped parts of the first magnet and the second magnet have polarities opposite to each other.

According to an embodiment, an input device includes a substrate including a sensor, a housing having an opening on the substrate, a sliding member slidably installed between the housing and the substrate, a sensing plate coupled with the sliding member to face a charge plate, a first magnet installed in the sliding member and having a ring shape, and a second magnet installed in the housing and having a ring shape, wherein the first magnet is at least partially overlapped with the second magnet in a horizontal direction, and the first magnet faces the second magnet so that repulsive force is generated therebetween.

### BRIEF DESCRIPTION OF THE DRAWINGS

FIG. 1 is a cross-sectional view showing an input device according to a first embodiment.

FIG. 2 is an exploded perspective view showing an input device according to a first embodiment.

FIG. 3 is a cross-sectional view showing an input device according to a second embodiment.

FIG. 4 is a view showing the arrangement of magnets of an input device according to a second embodiment.

FIG. 5 is a cross-sectional view showing an input device according to a third embodiment.

FIG. 6 is a view showing the arrangement of magnets in an input device according to a third embodiment.

FIG. 7 is a cross-sectional view showing an input device according to a fourth embodiment.

FIG. 8 is a view showing the arrangement of magnets in an input device according to a fourth embodiment.

FIG. 9 is a cross-sectional view showing an input device according to a fifth embodiment.

FIG. 10 is a view showing the arrangement of magnets in an input device according to a fifth embodiment.

FIG. 11 is a view showing the arrangement of magnets in an input device according to a sixth embodiment.

FIG. 12 is a cross-sectional view showing an input device according to a seventh embodiment.

FIG. 13 is a view showing the arrangement of magnets in an input device according to a seventh embodiment.

FIG. 14 is a cross-sectional view showing an input device according to an eighth embodiment.

FIG. 15 is a view showing the arrangement of magnets in an input device according to an eighth embodiment.

FIG. 16 is a cross-sectional view showing an input device according to a ninth embodiment.

FIG. 17 is a cross-sectional view showing an input device according to a tenth embodiment.

FIG. 18 is a cross-sectional view showing an input device according to an eleventh embodiment.

### DETAILED DESCRIPTION

Hereinafter, an input device according to embodiments will be described with respect to accompanying drawings.

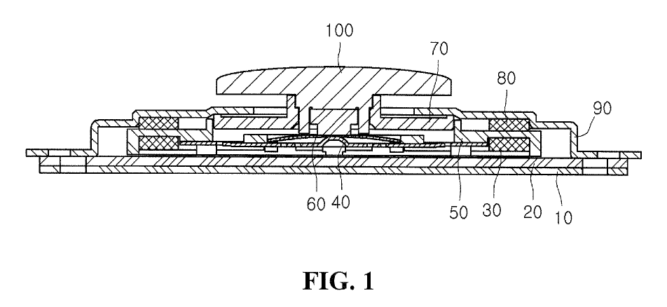

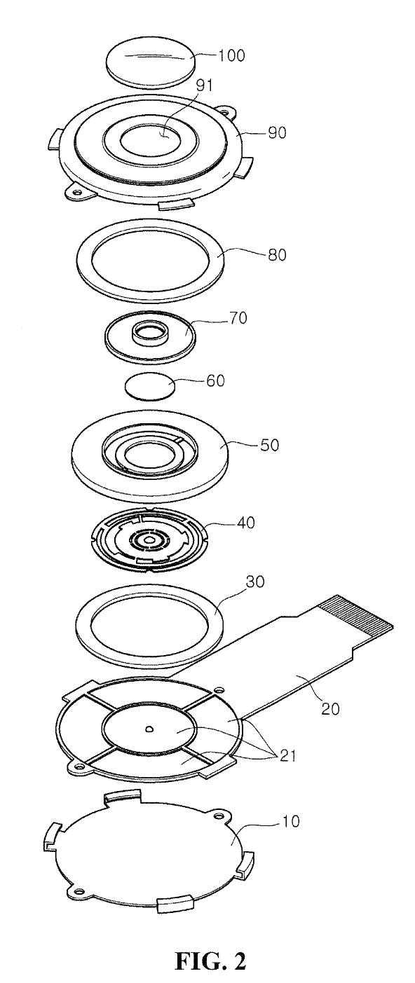

FIG. 1 is a cross-sectional view showing an input device according to a first embodiment, and FIG. 2 is an exploded perspective view of the input device according to the first embodiment.

Referring to FIGS. 1 and 2, the input device according to the first embodiment includes a base member 10 and a housing 90 coupled with the base member 10.

A substrate 20 is installed on the base member 10, and a sliding member 50 is provided on the substrate 20.

The substrate 20 is provided thereon with a charge plate 21 divided into a plurality of areas to serve as a sensor, and a sensing plate 40 is installed below the sliding member 50 facing the charge plate 21 such that the sensor can detect the sensing plate.

Capacitance of the charge plate 21 is remarkably changed according to the change of the position or the shape of the sensing plate 40. The manipulation command of a user can be recognized by detecting the variation in the capacitance of the charge plate 21. Since the sensing plate 40 is coupled with the sliding member 50, the position of the sensing plate 40 may be changed according to the movement of the sliding member 50.

A dome member 60 is provided on the sensing plate 40, and a button 70 is provided on the dome member 60. A portion of the button 70 may protrude out of an outside through an opening 91 of the housing 90, and a contact part 100 is provided on the button 70.

The contact part 100 helps a user to press or slide the button 70 by using user's finger or a pen. The contact part 100 may be selectively installed.

The button 70 is coupled with the sliding member 50 such that the sliding member 50 is slid by external force.

The button 70 applies force to the dome member 60 provided below the button 70 as the contact part 100 is pressed, and the dome member 60 changes the shape of the sensing plate 40 provided below the dome member 60. As the shape of the sensing plate 40 is changed, the capacitance of the charge plate 21 is changed to detect that the button 70 is pressed.

The dome member 60 has a convex-up shape and elasticity. Accordingly, when the button 70 is pushed down, a central portion of the dome member 60 is deformed downward and then returns to an original state thereof when the pressed button 70 is released. Accordingly, the button 70 is deformed downward as the button 70 is pushed down and then returns to an original state thereof due to elasticity of the dome member 60 when the pressed button 70 is released.

As the sliding member 50 moves, the position of the sensing plate 40 is changed on the charge plate 21, so that a command having directionality, such as the movement of a cursor, can be input through the input device. In addition, as the button 70 is pressed, the shape of the sensing plate 40 is changed on the charge plate 21, so that the input device can input the manipulation command such as a “click” representing a selection signal.

Meanwhile, after the sliding member 50 moves due to an external force, if the external force is removed, the sliding member 50 must return to an original position thereof.

To this end, the input device according to a first embodiment includes a magnet 30 and a magnetic substance 80.

The magnet 30 has a ring shape so as to be coupled with the sliding member 50, and the magnetic substance 80 has a ring shape so as to be coupled to the housing 90.

Since attractive force is generated between the magnet 30 and the magnetic substance 80, the sliding member 50 having the magnet 30 can be exactly restored to an original position thereof.

According to the first embodiment, although the magnet 30 is coupled with the sliding member 50 and the magnetic substance 80 is coupled with the housing 90, the magnetic substance 80 may be coupled with the sliding member 50, and the magnet 30 may be coupled with the housing 90.

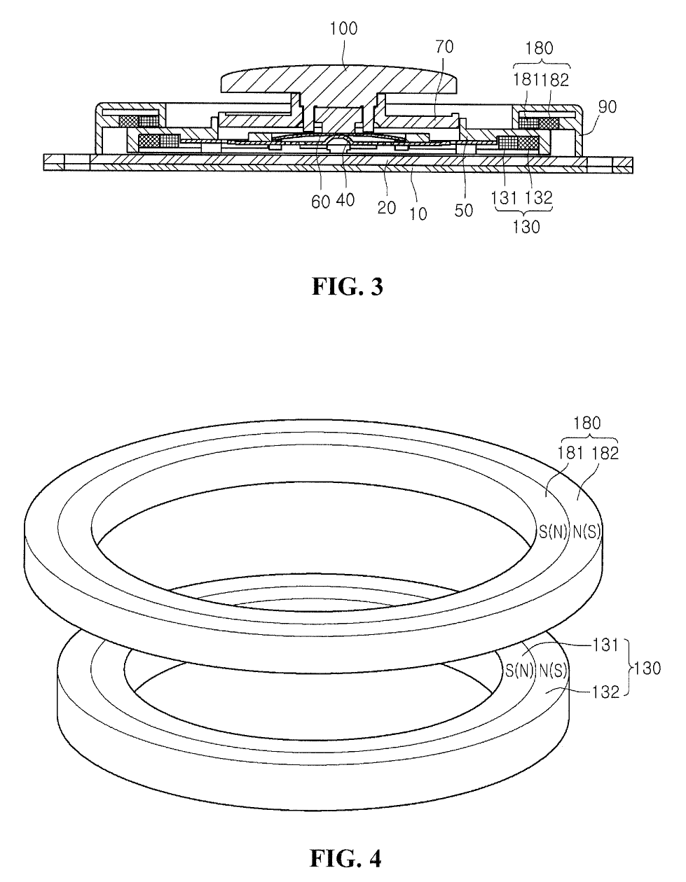

FIG. 3 is a cross-sectional view showing an input device according to a second embodiment, and FIG. 4 is a view showing the arrangement of magnets in the input device according to the second embodiment.

Details of elements the same as those of the first embodiment will be omitted in order to avoid redundancy.

In the input device according to the second embodiment, a first magnet 130 is installed in the sliding member 50, and a second magnet 180 is installed in the housing 90.

The first magnet 130 has a ring shape with a first radius, and the second magnet 180 has a ring shape with a second radius greater than the first radius so that the first magnet 130 is partially overlapped with the second magnet 180 in a vertical direction.

The first magnet 130 has a first polarity 131 at a region formed radially inward of the first magnet 130, and a second polarity 132 at a region formed radially outward of the first magnet 130. For example, the first polarity 131 may be an S-pole, and the second polarity 132 may be an N-pole. On the contrary, the first polarity 131 may be the N-pole, and the second polarity 132 may be the S-pole.

In addition, the second magnet 180 has a first polarity 181 at a region formed radially inward thereof and a second polarity 182 at a region formed radially outward thereof. For example, the first polarity 181 may be the S-pole, and the second polarity 182 may be the N-pole. On the contrary, the first polarity 181 may be the N-pole, and the second polarity 182 may be the S-pole.

As shown in FIG. 4, the second polarity 132 of the first magnet 130 is vertically overlapped with the first polarity 181 of the second magnet 180.

Accordingly, attractive force is generated between the second polarity 132 of the first magnet 130 and the first polarity 181 of the second magnet 180, and repulsive force is generated between the first polarity 131 of the first magnet 130 and the first polarity 181 of the second magnet 180. Repulsive force is generated between the second polarity 132 of the first magnet 130 and the second polarity 182 of the second magnet 180.

As a result, when external force is removed, the sliding member 50 can return to an original position thereof due to the force generated between the first and second magnets 130 and 180.

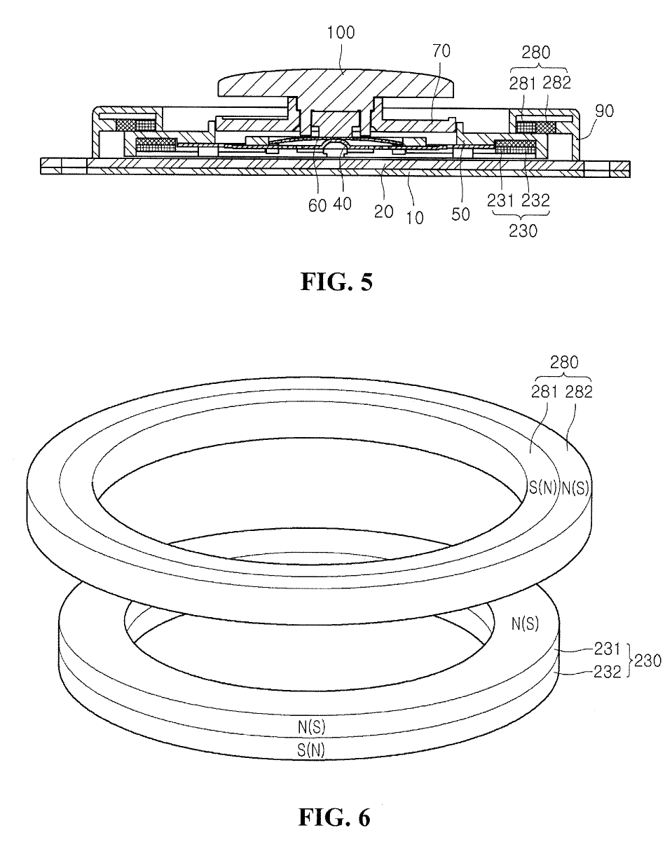

FIG. 5 is a cross-sectional view showing an input device according to a third embodiment, and FIG. 6 is a view showing the arrangement of magnets of the input device according to the third embodiment.

Details of elements the same as those of the first embodiment will be omitted in order to avoid redundancy.

In the input device according to the third embodiment, a first magnet 230 is installed in the sliding member 50, and a second magnet 280 is installed in the housing 90.

The first magnet 230 has a ring shape with a first radius, and the second magnet 280 has a ring shape with a second radius greater than the first radius, so that the first magnet 230 is partially overlapped with the second magnet 280 in a vertical direction.

An upper portion of the first magnet 230 has a first polarity 231 and a lower portion of the first magnet 230 has a second polarity 232. For example, the first polarity 231 may be the N-pole, and the second polarity 232 may be the S-pole. On the contrary, the first polarity 231 may be the S-pole, and the second polarity 232 may be the N-pole.

In addition, the second magnet 280 has a first polarity 281 at a region radially inward thereof and a second polarity 282 at a region formed radially outward thereof. For example, the first polarity 281 may be the S-pole, and the second polarity 282 may be the N-pole. On the contrary, the first polarity 281 may be the N-pole, and the second polarity 282 may be the S-pole.

As shown in FIG. 6, the first polarity 231 of the first magnet 230 faces the first polarity 281 of the second magnet 280.

Accordingly, attractive force is generated between the first polarity 231 of the first magnet 230 and the first polarity 281 of the second magnet 280, and repulsive force is generated between the first polarity 231 of the first magnet 230 and the second polarity 282 of the second magnet 280.

As a result, when external force is removed, the sliding member 50 can return to an original position thereof due to force generated between the first and second magnets 230 and 280.

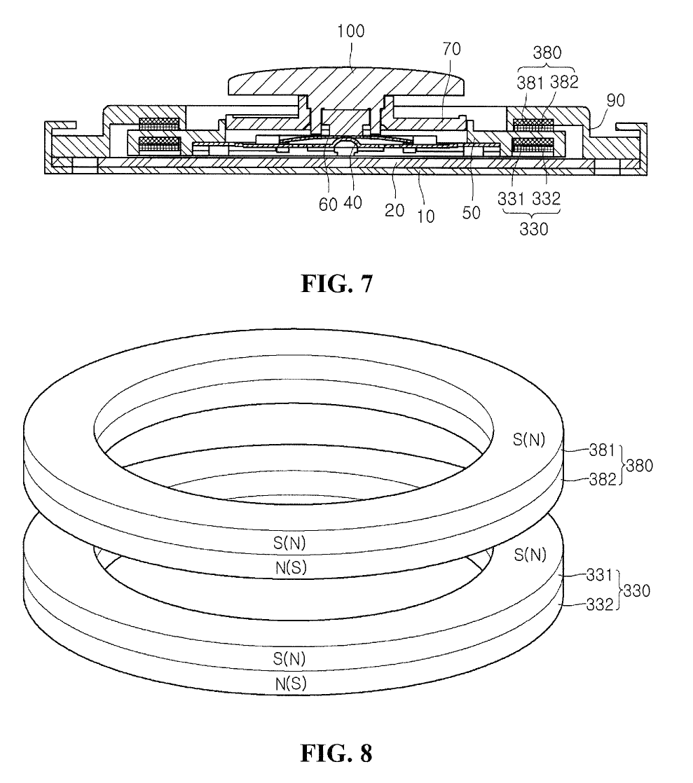

FIG. 7 is a cross-sectional view showing an input device according to a fourth embodiment, and FIG. 8 is a view showing the arrangement of magnets of the input device according to the fourth embodiment.

Details of elements the same as those of the first embodiment will be omitted in order to avoid redundancy.

In the input device according to the fourth embodiment, a first magnet 330 is installed in the sliding member 50, and a second magnet 380 is installed in the housing 90.

The first magnet 330 has a ring shape with a first radius, and the second magnet 380 has a ring shape with a radius equal to the first radius, so that the first magnet 330 is vertically overlapped with the second magnet 380.

An upper portion of the first magnet 330 has a first polarity 331, and a lower portion of the first magnet 330 has a second polarity 332. For example, the first polarity 331 is the S-pole, and the second polarity 332 is the magnet north pole. On the contrary, the first polarity 331 may be the N-pole, and the second polarity 332 is the magnet south pole.

In addition, an upper portion of the second magnet 380 has a first polarity 381 and a lower portion of the second magnet 380 has a second polarity 382. For example, the first polarity 381 may be the S-pole, and the second polarity 382 may be the N-pole. On the contrary, the first polarity 381 may be the N-pole, and the second polarity 382 may be the S-pole.

As shown in FIG. 8, the first polarity 331 of the first magnet 330 faces the second polarity 382 of the second magnet 380.

Accordingly, attractive force is generated between the first polarity 331 of the first magnet 330 and the second polarity 381 of the second magnet 380.

As a result, when external force is removed, the sliding member 50 can return to an original position thereof due to the force generated between the first and second magnets 330 and 380.

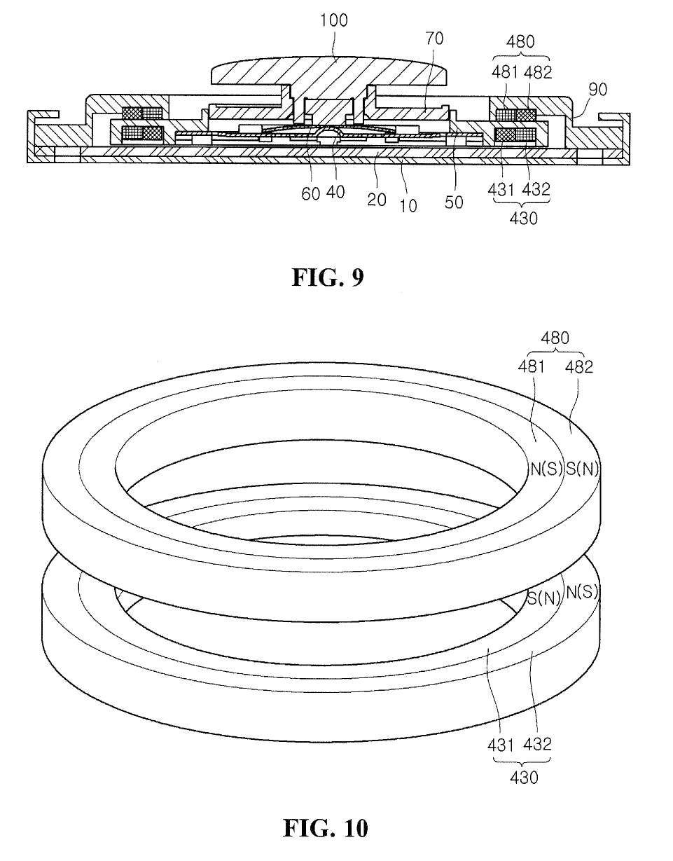

FIG. 9 is a cross-sectional view showing an input device according to a fifth embodiment, and FIG. 10 is a view showing the arrangement of magnets of the input device according to the fifth embodiment.

Details of elements the same as those of the first embodiment will be omitted in order to avoid redundancy.

In the input device according to the fifth embodiment, a first magnet 430 is installed in the sliding member 50, and a second magnet 480 is installed in the housing 90.

The first magnet 430 has a ring shape with a first radius, and the second magnet 480 has a ring shape with a radius equal to the first radius so that the first magnet 430 is overlapped with the second magnet 480 in a vertical direction.

The first magnet 430 has a first polarity 431 at a region formed radially inward thereof and a second polarity 432 at a region formed radially outward thereof. For example, the first polarity 431 may be the S-pole, and the second polarity 432 may be an N-pole. On the contrary, the first polarity 431 may be the N-pole, and the second polarity 432 may be the S-pole.

In addition, the second magnet 480 has a first polarity 481 at a region formed radially inward thereof and a second polarity 482 at a region formed radially outward thereof. For example, the first polarity 481 may be the N-pole, and the second polarity 482 may be the S-pole. On the contrary, the first polarity 481 may be the S-pole, and the second polarity 482 may be the N-pole.

As shown in FIG. 10, the first polarity 431 of the first magnet 430 faces the first polarity 481 of the second magnet 480, and the second polarity 432 of the first magnet 430 faces the second polarity 482 of the second magnet 480.

Accordingly, attractive force is generated between the first polarity 431 of the first magnet 430 and the first polarity 481 of the second magnet 480, and attractive force is generated between the second polarity 432 of the first magnet 430 and the second polarity 482 of the second magnet 480.

In addition, repulsive force is generated between the first polarity 431 of the first magnet 430 and the second polarity 482 of the second magnet 480, and repulsive force is generated between the second polarity 432 of the first magnet 430 and the first polarity 481 of the second magnet 480.

As a result, when external force is removed, the sliding member 50 can return to an original position thereof due to the force generated between the first and second magnets 430 and 480.

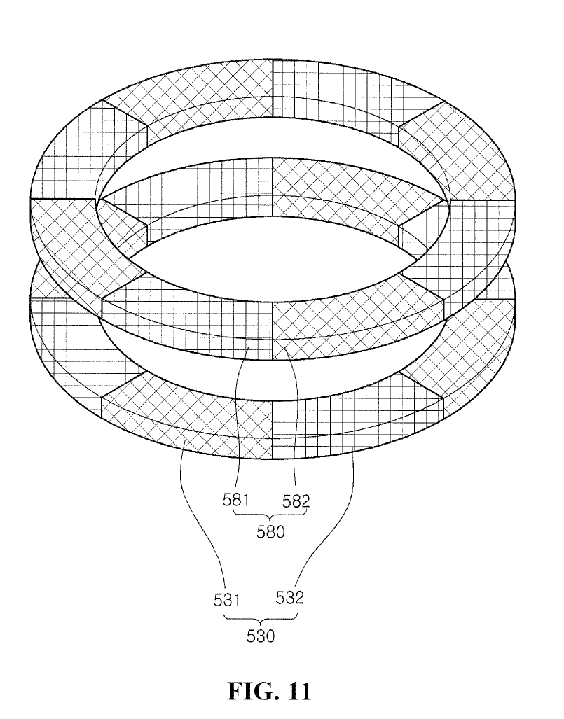

Hereinafter, the arrangement of the magnets in the input device according to the sixth embodiment will be described with reference to FIG. 11.

Similarly to the fifth embodiment, in the input device according to the sixth embodiment, a first magnet 530 is installed in the sliding member 50, and a second magnet 580 is installed in the housing 90.

The first magnet 530 has a ring shape with a first radius, and the second magnet 580 has a ring shape with a radius equal to the first radius so that the first magnet 530 is overlapped with the second magnet 580 in a vertical direction.

The first magnet 530 has a first polarity 531 and a second polarity 532 which are alternately aligned with each other in a radial direction. For example, the first polarity 531 may be the S-pole, and the second polarity 532 may be the N-pole. On the contrary, the first polarity 531 may be the N-pole, and the second polarity 532 may be the S-pole.

The second magnet 580 has a first polarity 581 and a second polarity 582 which are alternately aligned with each other in a radial direction. For example, the first polarity 581 may be the N-pole, and the second polarity 582 may be the S-pole. On the contrary, the first polarity 581 may be the N-pole, and the second polarity 582 may be the S-pole.

The first polarity 531 of the first magnet 530 faces the first polarity 581 of the second magnet 580, and the second polarity 532 of the first magnet 530 faces the second polarity 582 of the second magnet 580.

Accordingly, attractive force is generated between the first polarity 531 of the first magnet 530 and the first polarity 581 of the second magnet 580, and attractive force is generated between the second polarity 532 of the first magnet 530 and the second polarity 582 of the second magnet 580.

In addition, repulsive force is generated between the first polarity 531 of the first magnet 530 and the second polarity 582 of the second magnet 580, and repulsive force is generated between the second polarity 532 of the first magnet 530 and the first polarity 581 of the second magnet 580.

As a result, when external force is removed, the sliding member 50 returns to an original position thereof due to the force generated between the first and second magnets 530 and 580.

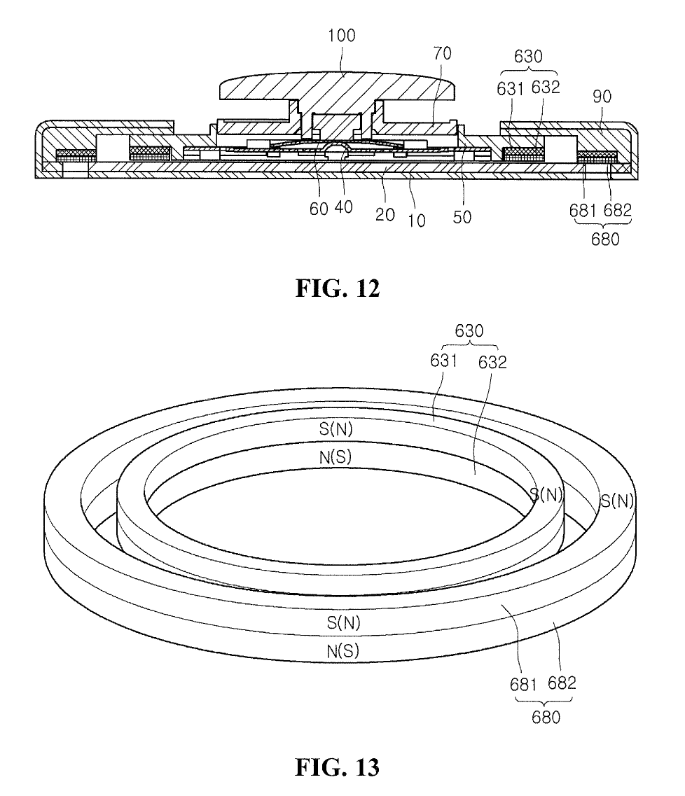

FIG. 12 is a cross-sectional view showing an input device according to a seventh embodiment, and FIG. 13 is a view showing the arrangement of magnets in the input device according to the seventh embodiment.

Details of elements the same as those of the first embodiment will be omitted in order to avoid redundancy.

In the input device according to the seventh embodiment, a first magnet 630 is installed in the sliding member 50, and a second magnet 680 is installed in the housing 90.

The first magnet 630 has a ring shape with a first radius, and the second magnet 680 has a ring shape with a second radius greater than the first radius, so that the first magnet 630 is provided within the radius of the second magnet 680.

The first magnet 630 is provided with a first height, and the second magnet 680 is provided with a second height, so that the first magnet 630 is partially overlapped with the second magnet 680 in a horizontal direction.

An upper portion of the first magnet 630 has a first polarity 631, and a lower portion of the first magnet 630 has a second polarity 632. For example, the first polarity 631 may be the S-pole, and the second polarity 632 may be the N-pole. On the contrary, the first polarity 631 may be the N-pole, and the second polarity 632 may be the S-pole.

In addition, an upper portion of the second magnet 680 has a first polarity 681, and a lower portion of the first magnet 680 has a second polarity 682. For example, the first polarity 681 may be the S-pole, and the second polarity 682 may be the N-pole. On the contrary, the first polarity 681 may be the N-pole, and the second polarity 682 may be the S-pole.

As shown in FIG. 13, the first polarity 631 of the first magnet 630 faces the first polarity 681 of the second magnet 680, and the second polarity 632 of the first magnet 630 faces the second polarity 682 of the second magnet 680.

Attractive force is generated between the second polarity 632 of the first magnet 630 and the first polarity 681 of the second magnet 680, repulsive force is generated between the first polarity 631 of the first magnet 630 and the first polarity 681 of the second magnet 680, and repulsive force is generated between the second polarity 632 of the first magnet 630 and the second polarity 682 of the second magnet 680. Accordingly, repulsive force is generated between the first magnet 630 and the second magnet 680.

As a result, when external force is removed, the sliding member 50 returns to an original position thereof due to the force generated between the first and second magnets 630 and 680.

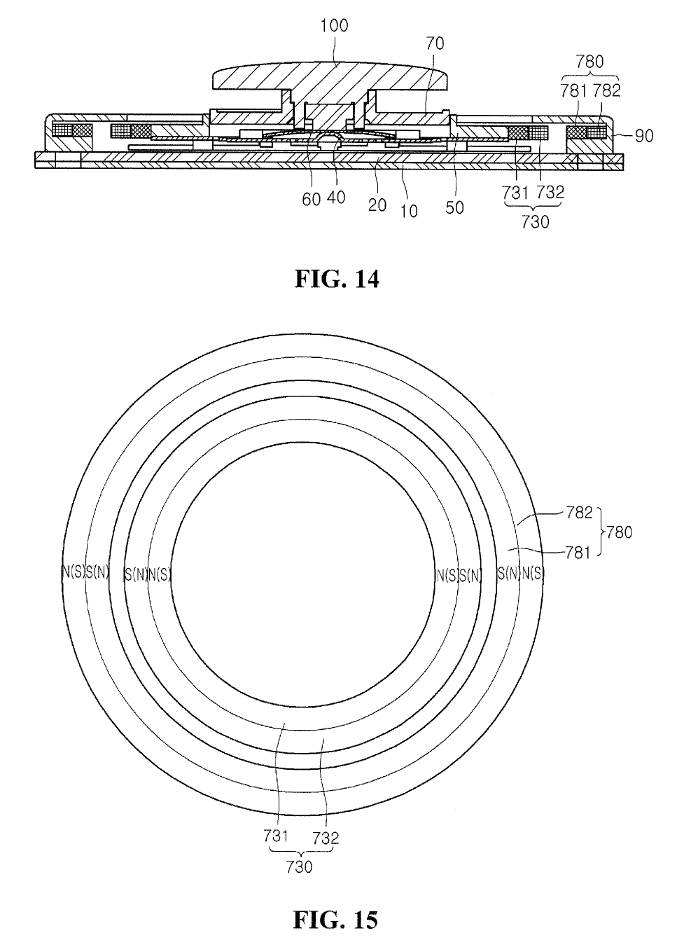

FIG. 14 is a cross-sectional view showing an input device according to an eighth embodiment, and FIG. 15 is a view showing the arrangement of magnets in the input device according to the eighth embodiment.

Details of elements the same as those of the first embodiment will be omitted in order to avoid redundancy.

In the input device according to the eighth embodiment, a first magnet 730 is installed in the sliding member 50, and a second magnet 780 is installed in the housing 90.

The first magnet 730 has a ring shape with a first radius, and the second magnet 780 has a ring shape with a second radius greater than the first radius, so that the first magnet 730 is provided in the second magnet 780.

The first magnet 730 has a first height, and the second magnet 780 has a second height substantially identical to the first height, so that the first magnet 730 is at least partially overlapped with the second magnet 780 in a horizontal direction.

The first magnet 730 has a first polarity 731 at a region formed radially inward thereof, and a second polarity 732 at a region formed radially outward thereof. For example, the first polarity 731 may be the N-pole, and the second polarity 732 may be the S-pole. On the contrary, the first polarity 731 may be the S-pole, and the second polarity 732 may be the N-pole.

The second magnet 780 has a first polarity 781 at a region radially inward thereof, and a second polarity 782 at a region radially outward thereof. For example, the first polarity 781 may be the S-pole, and the second polarity 782 may be the N-pole. On the contrary, the first polarity 781 may be the N-pole, and the second polarity 732 may be the S-pole.

As shown in FIG. 15, the second polarity 732 of the first magnet 730 faces the first polarity 781 of the second magnet 780.

Repulsive force is generated between the second polarity 732 of the first magnet 730 and the first polarity 781 of the second magnet 780.

As a result, when external force is removed, the sliding member 50 returns to an original position thereof due to the force generated between the first and second magnets 730 and 780.

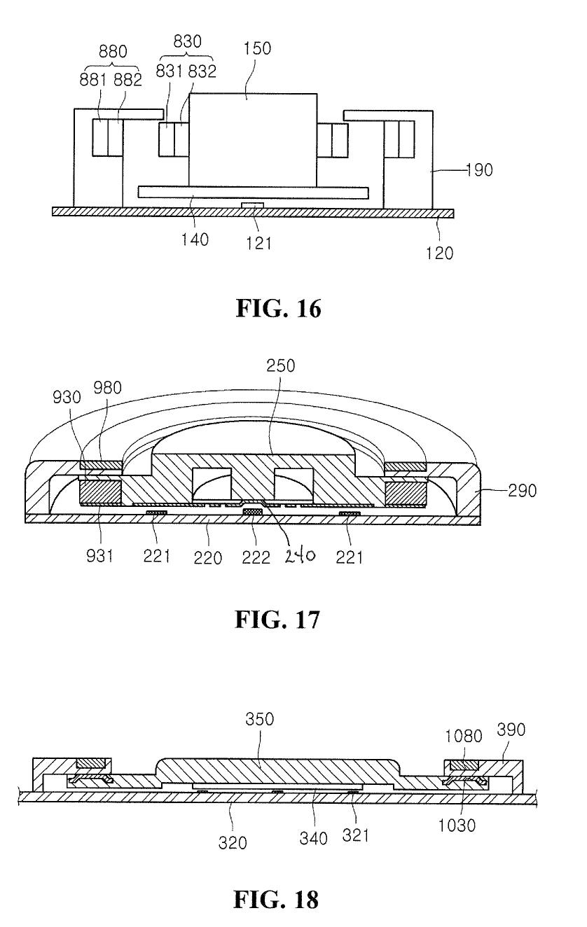

FIG. 16 is a cross-sectional view showing an input device according to a ninth embodiment.

In the input device according to the ninth embodiment, a sensing member 121 is installed on a substrate 120, and a housing 190 is provided on the substrate 120. A sliding member 150 is interposed between the housing 190 and the substrate 120, and a sensing plate 140 is installed below the sliding member 150 so as to be detected by the sensing member 121.

A first magnet 830 is installed in the sliding member 150, and a second magnet 880 is installed in the housing 190.

The first magnet 830 has first and second magnetic poles 831 and 832, and the second magnet 880 has first and second magnetic poles 881 and 882.

The first magnetic pole 831 of the first magnet 830 faces the second magnetic pole 882 of the second magnet 880, and the first magnetic pole 831 and the second magnetic pole 882 of the second magnet 880 have the same polarity. Accordingly, if an external force is not exerted, the sliding member 150 is stopped at a predetermined position due to repulsive force between the first magnet 830 and the second magnet 880.

The sensing member 121 detects a signal according to the position variation of the sensing plate 140 to output a value corresponding to the movement of the sliding member 150.

FIG. 17 is a cross-sectional view showing an input device according to a tenth embodiment.

In the input device according to the tenth embodiment, a sensing member 221 and a switching member 222 are mounted on a substrate 220, and a housing 290 is provided on the substrate 220. A sliding member 250 is interposed between the housing 290 and the substrate 220, and a sensing plate 240 is installed below the sliding member 250 so as to be detected by the sensing member 221 and the switching member 222.

A first magnet 930 is installed in the sliding member 250, and a second magnet 980 is installed in the housing 290. A back yoke 931 may be installed below the first magnet 930 in order to enhance magnetic force.

Attractive force is generated between the first magnet 930 and the second magnet 980.

Accordingly, if external force is not exerted, the sliding member 250 is stopped at a predetermined position due to attractive force between the first and second magnets 930 and 980.

The sensing member 221 detects a signal according to the position variation of the sensing plate 240 in a horizontal direction to output a value corresponding to the movement of the sliding member 250. In addition, the switching member 222 detects a signal according to the position variation of the sensing plate 240 in a vertical direction to output a value corresponding to the pressing degree of the sliding member 250. For example, when the sensing plate 240 is strongly pressed, the switching member 222 can output a signal.

FIG. 18 is a cross-sectional view showing an input device according to an eleventh embodiment.

In an input device according to the eleventh embodiment, a sensing member 321 is mounted on a substrate 320, and a housing 390 is provided above the substrate 320. A sliding member 350 is interposed between the housing 390 and the substrate 320, and a sensing plate 340 is installed below the sliding member 350 so as to be detected by the sensing member 321.

A magnetic substance 1030 may be installed in the sliding member 350, and a magnet 1080 may be installed in the housing 390. In addition, a magnet may be mounted on the sliding member 350, and a magnetic substance may be installed in the housing 390.

Attractive force is generated between the magnetic substance 1030 and the magnet 1080.

Accordingly, if external force is not exerted, the sliding member 350 is stopped at a predetermined position due to attractive force between the magnetic substance 1030 and the magnet 1080.

The sensing member 321 detects a signal according to the position variation of the sensing plate 340 to output a value corresponding to the movement of the sliding member 350.

As described above according to the embodiments, in the input device according to the embodiments, a magnet is installed in one of a sliding member and a housing, and a magnetic substance is installed in the other of the sliding member and the housing. Accordingly, the sliding member can return an original position thereof by using force generated between the magnet and the magnetic substance.

In addition, in the input device according to the embodiments, a first magnet is installed in the sliding member, and a second magnet is installed in a housing. Accordingly, the sliding member can return to an original position thereof by using force between the first magnet and the second magnet.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An input device comprising:
a substrate including a sensor;
a housing having an opening over the substrate;
a sliding member slidably installed between the housing and the substrate;
a sensing plate coupled with the sliding member to face the sensor; and
a magnetic substance circumferentially provided in one of the sliding member and the housing and a magnet circumferentially provided in remaining one of the sliding member and the housing.

2. The input device of claim 1, wherein at least one of the magnetic substance and the magnetic has a ring shape.

3. The input device of claim 1, wherein the magnetic substance is at least partially overlapped with the magnet in a vertical direction.

4. The input device of claim 1, wherein the sliding member is interposed between the magnetic substance and the magnet.

5. The input device of claim 1, further comprising a button coupled with the sliding member.

6. The input device of claim 5, further comprising a dome member interposed between the button and the sensing plate, a shape of the dome member being changed according to pressing of the button so that force is transmitted to the sensing plate.

7. An input device comprising:
a substrate including a sensor;
a housing having an opening over the substrate;
a sliding member slidably installed between the housing and the substrate;
a sensing plate coupled with the sliding member to face the sensor;
a first magnet installed in the sliding member and having a ring shape; and
a second magnet installed in the housing and having a ring shape, wherein the first magnet is at least partially overlapped with the second magnet in a vertical direction, and overlapped parts of the first magnet and the second magnet have polarities opposite to each other.

8. The input device of claim 7, wherein the first magnet has a first radius with a first magnetic pole formed radially inward thereof, and a second magnetic pole formed radially outward thereof;
wherein the second magnet has a second radius greater than the first radius with the first magnetic pole formed radially inward thereof and the second magnetic pole formed radially outward thereof; and
wherein the second magnetic pole of the first magnet is overlapped with the first magnetic pole of the second magnet in a vertical direction so that attractive force is generated therebetween.

9. The input device of claim 7, wherein the first magnet has a first radius, an upper portion of the first magnet has a first magnetic pole, and a lower portion of the first magnet has a second magnetic pole;
wherein the second magnet has a second radius greater than the first radius with the first magnetic pole formed radially inward thereof and the second magnetic pole formed radially outward thereof; and
wherein the first magnetic pole of the first magnet faces the first magnetic pole of the second magnet so that attractive force is generated therebetween.

10. The input device of claim 7, wherein the first magnet has a first radius, an upper portion of the first magnet has a first magnetic pole, and a lower portion of the first magnet has a second magnetic pole;
wherein the second magnet has a radius identical to the first radius, an upper portion of the second magnet has the first magnetic pole, and a lower portion of the second magnet has the second magnetic pole; and
wherein the first magnetic pole of the first magnet faces the second magnetic pole of the second magnet so that attractive force is generated therebetween.

11. The input device of claim 7, wherein the first magnet has a first radius with a first magnetic pole formed radially inward thereof and a second magnetic pole formed radially outward thereof;
wherein the second magnet has a radius identical to the first radius with the first magnetic pole formed radially inward thereof and the second magnetic pole formed radially outward thereof; and
wherein the first magnetic pole of the first magnet faces the second magnetic pole of the second magnet so that attractive force is generated therebetween, and the second magnetic pole of the first magnet faces the second magnetic pole of the second magnet so that attractive force is generated therebetween.

12. The input device of claim 7, wherein the first magnet has a first radius and is formed with first and second magnetic poles alternately aligned in a circumferential direction,
the second magnet has a radius identical to the first radius, and is formed with first and second magnetic poles aligned in a circumferential direction; and
the first magnetic pole of the first magnet faces the first magnetic pole of the second magnet so that attractive force is generated therebetween, and the second magnetic pole of the first magnet faces the second magnetic pole of the second magnet so that attractive force is generated therebetween.

13. The input device of claim 7, wherein the sliding member is interposed between the magnetic substance and the magnet.

14. The input device of claim 7, further comprising a button coupled with the sliding member.

15. The input device of claim 14, further comprising a dome member interposed between the button and the sensing plate, a shape of the dome member being changed according to pressing of the button so that force is transmitted to the sensing plate.

16. An input device comprising:
a substrate including a sensor;
a housing having an opening over the substrate;
a sliding member slidably installed between the housing and the substrate;
a sensing plate coupled with the sliding member to face a charge plate;
a first magnet installed in the sliding member and having a ring shape; and
a second magnet installed in the housing and having a ring shape, wherein the first magnet is at least partially overlapped with the second magnet in a horizontal direction, and the first magnet faces the second magnet so that repulsive force is generated therebetween.

17. The input device of claim 16, wherein the first magnet has a first radius, an upper portion of the first magnet has a first magnetic pole, and a lower portion of the first magnet has a second magnetic pole;
wherein the second magnet has a second radius greater than the first radius, an upper portion of the second magnet has the first magnetic pole, and a lower portion of the second magnet has the second magnetic pole; and
wherein the first magnetic pole of the first magnet faces the first magnetic pole of the second magnet so that repulsive force is generated therebetween, and the second magnetic pole of the first magnet faces the second magnetic pole of the second magnet so that repulsive force is generated therebetween.

18. The input device of claim 16, wherein the first magnet has a first radius with a first magnetic pole formed radially inward thereof and a second magnetic pole formed radially outward thereof;
wherein the second magnet has a second radius greater than the first radius with the first magnetic pole formed radially inward thereof and the second magnetic pole formed radially outward thereof; and
wherein the second magnetic pole of the first magnet faces the first magnetic pole of the second magnet so that repulsive force is generated therebetween.

19. The input device of claim 16, further comprising a button coupled with the sliding member.

20. The input device of claim 19, further comprising a dome member interposed between the button and the sensing plate, a shape of the dome member being changed according to pressing of the button so that force is transmitted to the sensing plate.
